(19) United States
(12) Patent Application Publication
(10) Pub. No.: US 2015/0002674 A1
(43) Pub. Date: Jan. 1, 2015

(54) INTEGRATED VEHICLE TRAFFIC CAMERA

(71) Applicant: FORD GLOBAL TECHNOLOGIES, LLC, Dearborn, MI (US)

(72) Inventors: Robert Bruce Kleve, Dearborn, MI (US); Brian Wolski, Dearborn, MI (US); Anthony Gerald King, Ann Arbor, MI (US)

(21) Appl. No.: 13/927,385

(22) Filed: Jun. 26, 2013

(51) Int. Cl. H04N 7/18; B60R 11/04; G06K 9/00

(52) U.S. Cl. CPC H04N 7/18; G06K 9/00771; B60R 11/04
USPC 348/149

(57) ABSTRACT

One exemplary illustration of a vehicle video recording system may include an on-vehicle camera generating a video signal indicative of video data, at least one sensor, a RAM device and a controller communicatively coupled to the camera, the sensor and the RAM device. The controller may determine a recording duration based on sensor data received from the sensor. Further, the controller may store the video data and the associated sensor data to the RAM device for the recording duration. The controller may transfer video data and associated sensor data from the RAM device to a storage device in response to receiving a save-event signal from the sensor.

### BACKGROUND

Digital video recording systems for vehicles are known. As one example, video recording systems may be installed in police vehicles to capture video for use in prosecution of criminal traffic violations. These systems can be programmed to turn on automatically when the vehicle siren is activated or when the vehicle exceeds a certain speed.

Video recording systems for consumer vehicles are also known. These systems typically are configured to capture video without regard to statutes or municipal regulations that may prohibit such video recording where the vehicle is currently traveling. Furthermore, the typical recording system may be configured to begin recording video without regard to any inconsistency by which a driver may be operating the vehicle. In addition, the typical system may not be configured to start recording video based on inclement weather conditions, poor road conditions or any particular driver who may require close monitoring.

It would therefore be desirable to provide an integrated vehicle video recording system and method of selectively capturing video while reducing the risk of violating local privacy laws for jurisdictions in which the vehicle may be currently travelling.

### SUMMARY

One exemplary illustration of a vehicle video recording system may include an on-vehicle camera generating a video signal indicative of video data, at least one sensor, a RAM device and a controller communicatively coupled to the camera, the sensor and the RAM device. The controller may determine a recording duration based on sensor data received from the sensor. Further, the controller may store the video data and the associated sensor data to the RAM device for the recording duration. The controller may transfer video data and associated sensor data from the RAM device to a storage device in response to receiving a save-event signal from the sensor.

Further, one embodiment of a method of capturing video from a vehicle may include the step of generating a video signal on an on-vehicle camera. In addition, the method may also include generating a save-event signal in response to detecting a vehicle event. The method may further include storing sensor data generated by at least one sensor and video data based on the video signal in a RAM device, in response to a controller receiving the save-event signal. The method may also include transferring the sensor data and the video data from the RAM device to a storage device in response to a controller receiving the save-event signal from the sensor.

### BRIEF DESCRIPTION OF THE DRAWINGS

FIG. 1 is a schematic block diagram of one embodiment of a vehicle video recording system that stores video data on an off-board server communicatively coupled to the system through the cloud;

FIG. 2 is a schematic block diagram of another embodiment of the vehicle video recording system of FIG. 1, showing the system storing video data on a storage interface in the form of a USB memory stick;

FIG. 3 is a schematic block diagram of one embodiment of a human machine interface for the vehicle video recording system of FIG. 1; and

FIG. 4 is a flowchart depicting one embodiment of a method for operating the system of FIG. 1.

### DETAILED DESCRIPTION

Referring now to the discussion that follows and also to the drawings, illustrative approaches are shown in detail. Although the drawings represent some possible approaches, the drawings are schematic in nature and thus not drawn to scale, with certain features exaggerated or removed to better illustrate and explain the present disclosure. Further, the descriptions set forth herein are not intended to be exhaustive or otherwise limit or restrict the claims to the precise forms and configurations shown in the drawings and disclosed in the following detailed description.

An exemplary video recording system for a vehicle may be configured to automatically record video in response to various road conditions, vehicle operating conditions and other events internal and external to the system. The system may be further configured to suspend recording video when the vehicle is located in jurisdictions having laws or regulations prohibiting video surveillance. The recording system may include an on-vehicle camera that captures video of an event that is deemed potentially worth capturing and saving. The system may further include a GPS receiver and a storage device, which stores video data and a reference lookup table or database of jurisdictions that prohibit video surveillance. When the GPS receiver detects that the vehicle enters a restricted location or jurisdiction prohibiting video surveillance, the recording system may disable the camera, the storage device or both components to prevent video from being recorded.

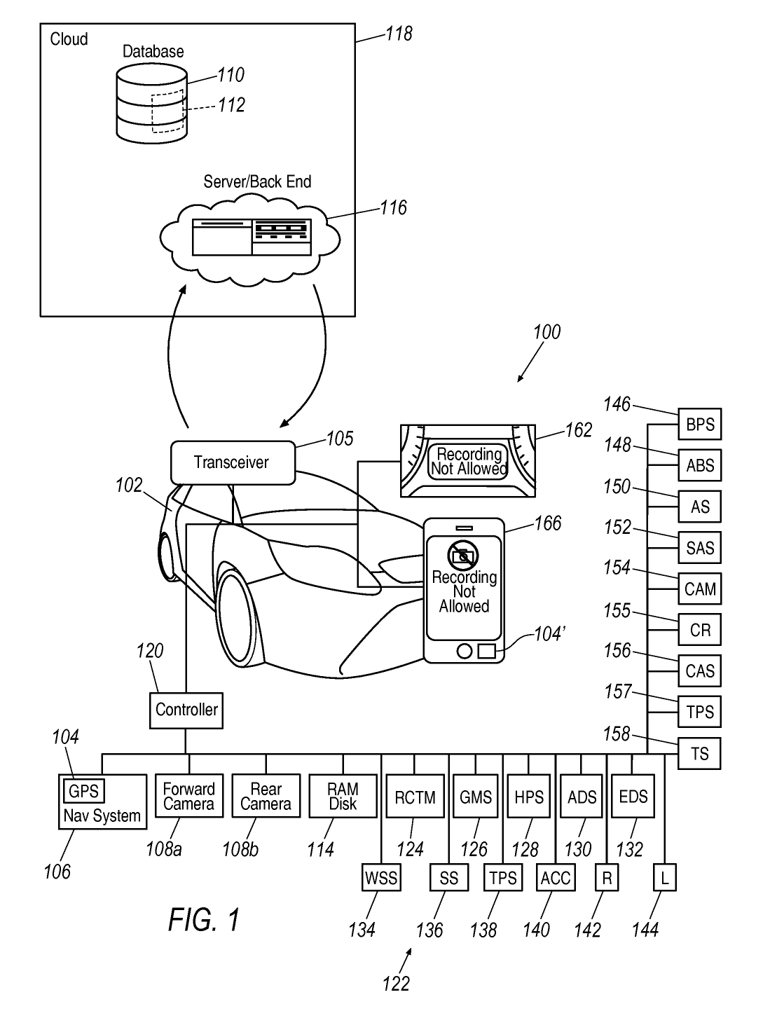

Referring to FIG. 1, one embodiment of a video recording system 100 (“recording system”) integrated in a vehicle 102 may include a receiver 104, e.g. a GPS receiver, that acquires or generates a position signal indicative of a current vehicle location. The receiver 104 may be an on-board component of another vehicle system, such as a vehicle navigation system 106. In this respect, the recording system 100 may utilize common vehicle components, which may be beneficial to minimize vehicle weight, improve fuel economy and decrease vehicle cost. In another embodiment, the GPS receiver may be a separate component used exclusively for the recording system 100. Moreover, in still another embodiment, the receiver 104′ may be an off-board component of a handheld wireless device, such as a mobile phone, which utilizes a cloud-based mapping application. The off-board component may be communicatively coupled to an on-vehicle transceiver 105. The transceiver may be one of many forms, including cellular and WiFi communication devices, Bluetooth controlled cellular devices or various other wireless communication devices.

The recording system 100 may further include one or more on-vehicle cameras 108a, 108b carried by the vehicle 102. For example, the recording system 100 may include one or more forward-looking cameras 108a, which may be installed on a dashboard, windshield, behind a front grill, on a rear view mirror or on other suitable portions of the vehicle. In addition, the recording system 100 may include one or more rearward-looking cameras 108b, which may be installed on a rear deck lid, a rear window or other portions of the vehicle 102. Moreover, the recording system 100 may include other cameras mounted to other portions of the vehicle and arranged in other directions to provide, for example, lateral outboard side views or interior views of the passenger cabin.

The recording system 100 may also include a storage device 110 that stores a reference lookup table 112 or database of jurisdictions in which on-vehicle video surveillance may be prohibited unless, for example, all parties consent to the recording. The table 112 may further include data or disable signals, which are associated with corresponding restricted locations and indicative of the illegality of recording video in those restricted locations. The storage device 110, in this form, may be communicatively coupled to a secured encrypted server 116 associated with a wireless network 118 or the cloud.

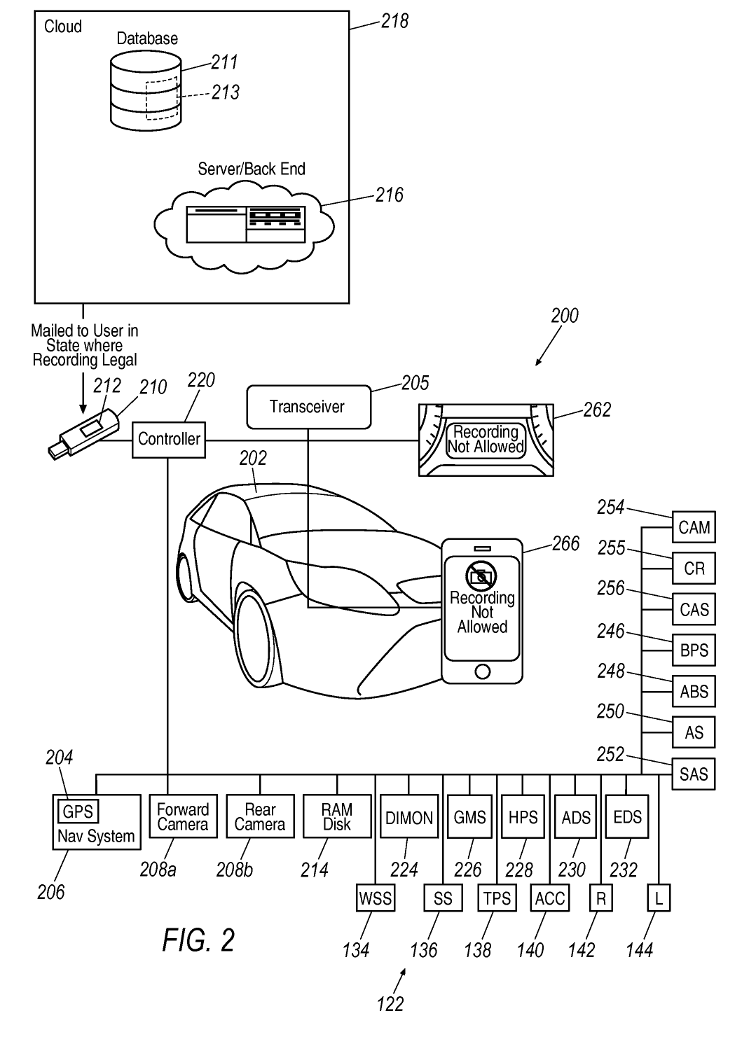

Referring to FIG. 2, the storage device may be a mobile storage medium 210, such as a USB memory stick device or an SD memory card, which may be prepared and encrypted, e.g., by an insurance carrier and then provided to the driver. However, the system may include other forms of authentication or none as desired. FIG. 2 illustrates another embodiment of a recording system 200 having the same elements as the recording system 100 as numbered in the 200 series. In this example, the insurance carrier may have its own server 216 and database 211 for installing or downloading the reference lookup table 212 from the database 211 onto the memory stick device 210, and encrypt the memory stick device 210 for storing video data captured only by the authorized driver, as permitted by the data contained within the lookup table. However, the storage device may be an on-vehicle data storage device or a mobile device connected to the controller over wire or wirelessly through the vehicle communication systems, such as SYNC. Examples of the mobile device may include a phone, a tablet computer or other mobile device with a storage medium.

Referring to FIG. 1, the recording system 100 may further have a controller 120 communicatively coupled to the receiver 104, the camera 108a, 108b and the storage device 110. The controller 120 may be configured to receive the position signal, which is generated by the GPS device 104 and indicative of the current vehicle location. The controller 120 may then access the reference lookup table on the storage device 110 and determine whether the current vehicle location is one of the restricted locations, such that the controller 120 may further determine the disable data or disable signal associated with the restricted location. The controller 120 may then disable the camera 108 to suspend capturing video, in response to the disable signal. In addition, the controller 120 may suspend transferring the video data from a RAM device 114 to the storage device 110, in response to the disable signal.

The RAM device 114 may be a buffer or temporary memory storage device communicatively coupled with the camera 108, the storage device 110 and the controller 120, such that the RAM device 114 may receive the video signal from the camera 108 and temporarily store video data associated with the video signal. The RAM device 114, the storage device 110 and all signals are non-transitory, including all computer-readable media, with the sole exception being a transitory propagating signal per se.

The recording system 100 may also include one or more sensors 122, which may provide sensor data related to a current vehicle condition and may be utilized by the controller to determine a recording duration. In particular, the sensor may be a stand-alone sensor that directly detects a vehicle condition or any module, such as a collision avoidance sensor module, that generates an output indicative of a vehicle condition. These sensors may be communicatively coupled to the controller 120 and selectively generate sensor data and a related a high-risk signal, indicative of the vehicle being at a high risk for a crash or other vehicle event potentially having recordable value (“recordable event”). The controller 120 may then receive the high-risk signal from the sensor 122 and actuate the camera 108 to store a predetermined size or duration of video data on the RAM device 114 in response to the high-risk signal. For example, the sensor 122, in one form, may be a Road Curvature and Traffic Monitor Module (“RCTM”) configured to generate a high-risk signal indicative of an associated risk of a vehicle crash. If the controller receives the high-risk signal from the RCTM 124, the controller may actuate the camera 108 to store a predetermined length of video, such as 10 minutes, on the RAM device 114. In the high risk condition, the controller 120 may actuate the camera to capture or record a duration of video that is extended, as compared to a duration of video captured by the camera when the controller determines that the vehicle is not in a high risk condition. The controller may then store the video on the RAM device 114 in a loop that may overwrite previously recorded video. If the controller 120 does not receive the high-risk signal from the sensor 122, the controller 120 may actuate the camera 108 and RAM device 114 to capture and store video data for a shorter period of time than the time used to record video in the high risk situation.

Other examples of the sensors 122 may include a gaze monitor sensor 126 or a head pose sensor 128 for measuring driver distraction, which are also indicative of a high risk situation requiring longer recording time. Further, the sensors 122 may also include an aggressive driving sensor 130, an eco-driving sensor 132, a wheel speed sensor 134, a wheel slip sensor 136, a tire pressure sensor 138, an accelerometer 140, a radar device 142, a lidar device 144, a brake pressure sensor 146, an anti-locking brake sensor 148, an airbag sensor 150, a steering angle sensor 152, an infrared camera 154, a dedicated short range communications receiver 155, a receiver 104, a collision avoidance sensor 156, a throttle position sensor 157 and a torque sensor 158, for detecting a pre-crash event.

As one example, the accelerometer 140 may generate the high-risk signal in response to detecting a lateral acceleration that is higher than a predetermined lateral acceleration threshold, such as an acceleration that may be greater than the cornering capability of the vehicle on dry pavement. This amount of lateral acceleration may indicate a high risk for an imminent crash or other recordable event. As another example, the accelerometer 140 may generate the high-risk signal in response to detecting a vehicle longitudinal deceleration that is higher than a predetermined deceleration threshold. A deceleration exceeding this threshold may indicate that the full brake pressure may be applied immediately before a crash or other recordable event. As another example, the controller may receive a high-risk signal from the cloud and indicative of, for example, weather providing slippery road conditions. By way of another example, the accelerometer may generate the high-risk signal in response to detecting a vehicle acceleration in a vertical direction that is higher than a predetermined acceleration threshold.

Furthermore, the controller 120 may access the reference lookup table 112 on the storage device 110 and determine that the current steering angle and wheel speed, as indicated by signals from the respective sensors 152 and 134, exceed associated thresholds stored on the table 112. This threshold may be determined based on empirical data for the vehicle 102, as driven on various driving surfaces, such as pavement, dirt, gravel or grass, or a predetermined location such as a restricted access highway or a two-lane road. In addition, the controller may adjust or offset the threshold based on the current weather, as received from the cloud or other wireless connection to an off-board server. That is, the threshold may be lowered for icy or wet road conditions, in high traffic volume or expected change of speed from traffic information. In other embodiments, the thresholds may be lowered based on driver profile, such as a profile of an adolescent driver.

The recording system 100 may further include one or more sensors 122 that are communicatively coupled to the controller 120 and configured to generate a save-event signal, indicative of the actual occurrence of a recordable event thereby requiring long term storage of the video on the storage device 110. The controller 120 may be configured to receive the save-event signal from the sensor 122 and transfer the related video data and sensor data from the RAM device 114 to the storage device 110, in response to receiving the save-event signal from the sensor 122. The data may be transferred from RAM to ROM, flash memory or to a mobile device for storage through a suitable vehicle communication system, including but not limited to SYNC. This data may include data from any or all of the sensors, as well as time identification and vehicle or driver profile.

The sensors 122 may be configured to detect various conditions related to the vehicle, the current route, the current driver and the current weather. As an example, one sensor 122 detecting the occurrence of a recordable event may include an airbag sensor 150 that generates the save-event signal in response to detecting an airbag deployment. The sensors 122 may also include a brake pressure sensor 146 that generates the save-event signal in response to detecting a current brake pressure higher than a predetermined brake pressure threshold. Further, the sensors 122 may also include the accelerometer 140, which detects a lateral acceleration exceeding a second lateral acceleration threshold that is higher than the initial lateral acceleration threshold previously used to detect a high-risk vehicle situation that initiated recording of video data on the RAM device 114. Similarly, the accelerometer may detect a deceleration exceeding a second deceleration threshold that is a higher than the initial deceleration threshold previously used to detect the high-risk vehicle situation. In this respect, the high-risk signal may be used to determine the length of the video data to be stored on the RAM device in the short term, while the save-event signal may be used to determine which video data to store on the storage device 110 for a longer period of time.

Still another sensor 122 may be the receiver 104 generating the save-event signal indicative of at least one of a current vehicle location, a current vehicle compass heading, a current road condition, a current or approaching road type, a predicted travel path, an expected travel path, and a current or approaching traffic condition. The controller 120 may store a driver profile including at least one driver performance parameter, and then transfer video data from the RAM device 114 to the storage device 110, in response to the sensor 122 generating the save-event signal that indicates that a current vehicle condition deviates from the at least one driver performance parameter by more than a predetermined threshold. For example, the save-event signal may indicate that a current vehicle speed at a current location is more than an archived vehicle speed at the current location for the driver profile, or a posted speed limit detected by a traffic sign recognition system TSR, and the controller 120 may then transfer the video data from the RAM device 114 to the storage device 110. Examples of driver performance parameters include the experience level of the driver, age of the driver and the performance history of the driver.

However, the controller 120 may not receive the save-event signal during the video recording or at its conclusion. Accordingly, the controller 120 may be configured to delete video data from the RAM device 114, without saving the video data to the storage device 110.

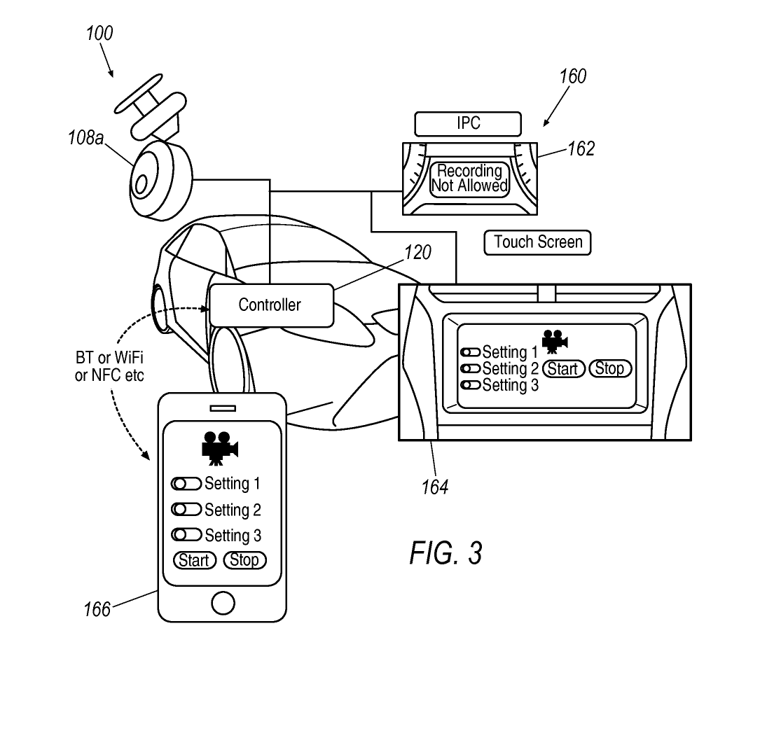

Referring to FIG. 3, the recording system 100 may also include a human machine interface 160 that is communicatively coupled to the controller 120 and integrated within at least one of an on-vehicle instrument panel cluster 162, an on-vehicle touch screen display 164 and a mobile wireless device, such as a mobile phone 166. Other examples of interfaces connected to the controller may include a voice recognition controller interface 167 and a mechanical switch interface 169. The human machine interface 160 may be communicatively coupled to the controller 120 and configured to communicate a message indicating a status of the recording system 100, in response to the controller transmitting a status signal to the human machine interface. For example, the human machine interface may include any suitable video player, audio player, multimedia player or instrumentation that communicates that the recording system 100 has been disabled, in response to the controller 120 transmitting a disable signal to the human machine interface 160. The interface may be used to indicate the state of the system to the user and the indication may be visual, audible, or haptic.

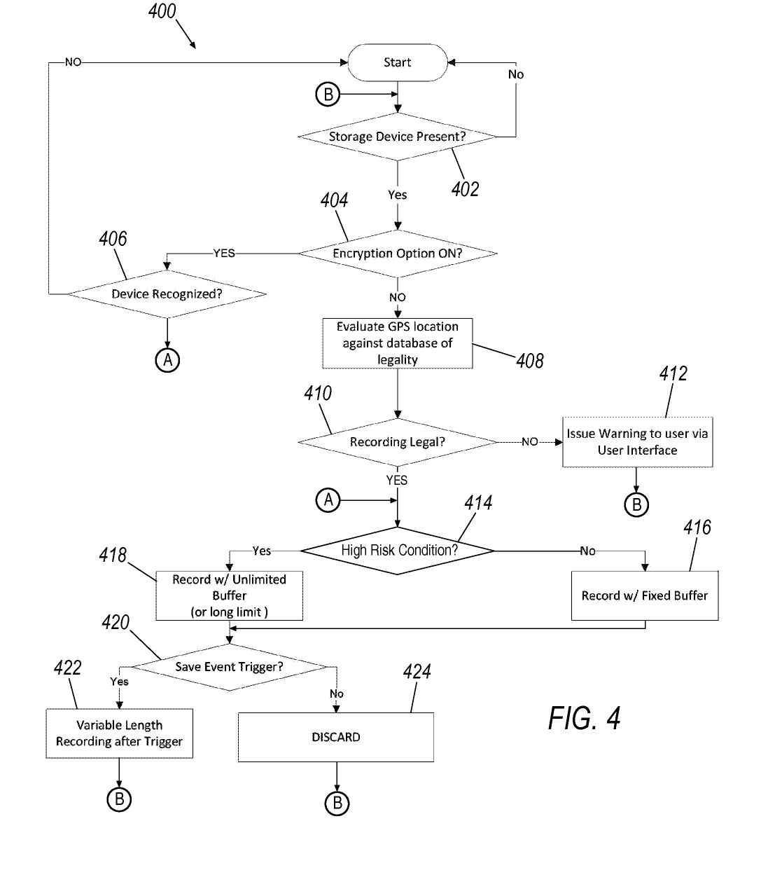

FIG. 4 illustrates a flowchart for one embodiment of a method 400 of operating the recording system 100 of FIG. 1 to capture video from the vehicle 102. At step 402, the recording system 100 may determine whether the storage device 110 is communicatively coupled to the controller 120. For example, this step may be accomplished by the controller determining whether the USB memory stick 216 is connected to an on-vehicle electrical socket or female connector communicatively coupled to the on-vehicle controller 220 (FIG. 2). In another embodiment, this step may be accomplished by detecting a wireless connection between the controller 120 and off-board server 116 associated with the cloud or a network (FIG. 1). If the storage device 110 is not communicatively coupled to the controller, the method repeats step 402. However, if the storage device 110 is communicatively coupled to the controller, the method continues to step 404.

At step 404, the controller 120 may determine whether the storage device 110 is encryption enabled or otherwise secured. If so, the method continues to step 406. If not, however, the method continues to step 408.

At step 406, the controller 120 may determine whether the storage device 110 is recognized or otherwise authenticated. If not, the method may return to step 402. If the storage device 110 is recognized or otherwise authenticated, the method may continue to step 414.

At step 408, a receiver 104 may receive and generate a position signal indicative of a current vehicle location. This step, in one form, may be accomplished using a GPS receiver that is a component of an on-board vehicle navigation system 106. However, in another embodiment, this step may be accomplished using a GPS receiver integrated within a handheld device, such as a mobile phone. The method may continue to step 410.

At step 410, the controller 120 may determine if video surveillance by the recording system is legal in the local jurisdiction. In particular, the controller 120 may access the reference lookup table 112 on the storage device 110 and determine whether the current vehicle location is one of the restricted locations or jurisdictions that prohibit video surveillance. If the current vehicle location is a restricted location, the method proceeds to step 412. However, if the controller 120 determines that the current vehicle location is not a restricted location, the method continues to step 414.

At step 412, the controller 120 may send a disable signal to the human machine interface 160, which may display a message notifying the occupants that the local jurisdiction prohibits video surveillance and further that the video recording has been suspended. The HMI, in one form, may permit the occupant to override the disable signal and manually actuate the camera 108 to capture video and store the same on the storage device 110. The method then returns to step 402.

At step 414, the controller 120 may determine whether the vehicle is or will likely be in a situation that would merit recording. That is, the controller may determine whether the vehicle is in a high risk condition for a recordable event. This step may be accomplished by utilizing the sensors 122, which may generate a high-risk signal indicative of the high risk condition upon detecting the same. For example, the controller 120 may receive the high-risk signal generated by the accelerometer 140, in response to the accelerometer 140 detecting that a deceleration exceeding an initial deceleration threshold which may be associated with the application of maximum break pressure before a potential collision. Other examples of these sensors 122 may include the RCTM 124, the gaze monitor sensor 126 , the head pose sensor 128, the aggressive driving sensor 130, the eco-driving sensor 132, the wheel speed sensor 134, the wheel slip sensor 136, the tire pressure sensor 138, the accelerometer 140, the radar device 142, the lidar device 144, the brake pressure sensor 146, the anti-locking brake sensor 148, the airbag sensor 150, the steering angle sensor 152, the infrared camera 154, the dedicated short range communications receiver 156, the receiver 104 and the collision avoidance sensor 156. The controller may utilize the high-risk signal in conjunction with the reference lookup table to confirm the high-risk condition of the vehicle. However, various other sensors may be used to accomplish this step. If the controller 120 does not receive the high-risk signal from any of the sensors, the method may continue to step 416. If, however, the controller 120 receives the high-risk signal from any of the sensors, the method may continue to step 418.

At step 416, the controller 120 may actuate the camera 108 to capture a predetermined length of video and then store the associated video data on the RAM device 114. The length of the video may be, for example, 10 minutes; however, the length may be shorter or longer than 10 minutes, so as to sufficiently capture the event for which such recording was triggered. However, this step may be accomplished by the controller 120 actuating the camera to capture and record the extended length of data. The method may proceed to step 420.

At step 418, the controller 120 may actuate the camera 108 to capture video for a longer period of time as compared to step 416, and then store the associated video data on the RAM device 114. In one embodiment, the controller 120 may actuate the camera 108 to capture video for the extended time in a loop by overwriting previously recorded video. The method may proceed to step 420.

At step 420, the controller 120 may determine whether the video captured by the camera 108 should be saved for a longer period of time on the storage device 110, as compared to the length of time the video is stored on the RAM device 114. In this respect, the controller 120 may determine whether to transfer the video data from the RAM device 114 to the storage device 110. This step may be accomplished by determining whether the controller 120 receives a save-event signal from the sensor 122, which indicates that the high-risk recordable event had actually occurred. Continuing with a previous example, this step may be accomplished by the controller 120 receiving a save-event signal generated from the accelerometer 140, in response to the accelerometer 140 detecting a deceleration exceeding a second deceleration threshold. The second deceleration threshold may be greater than the first deceleration threshold. This step may be further accomplished by the controller 120 receiving a save-event signal generated by the airbag sensor 150, in response to the airbag sensor detecting deployment of one or more airbags. If the controller 120 determines that the recordable event had actually occurred and was captured by the camera 108 and stored on the RAM device 114, the method may proceed to step 422. If not, the method continues to step 424.

At step 422, the controller 120 may send an actuation signal to the camera 108, which may in turn continue capturing video for a predetermined remaining length of time that may be varied based on the associated sensor and then store the video data to the storage device 110. The controller 120 may further transfer the previously recorded video data from the RAM device 114 to the storage device 110. The method may then return to step 402.

At step 424, the controller 120 may send an actuation signal to the camera 108 to disable the camera and suspend or terminate recording and further to delete associated video data from the RAM device 114. The method may then return to step 402.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

What is claimed as new and desired to be protected by Letters Patent of the United States is:

1. A vehicle video recording system, comprising:
an on-vehicle camera generating a video signal indicative of video data;
at least one sensor;
a RAM device;
a controller communicatively coupled to the camera, the at least one sensor and the RAM device;
wherein the controller determines a recording duration based on sensor data received from the at least one sensor;
wherein the controller stores the video data and the associated sensor data to the RAM device for the recording duration;
wherein the controller transfers video data and sensor data from the RAM device to a storage device in response to receiving a save-event signal from the at least one sensor.

2. The vehicle video recording system of claim 1, further comprising:
a receiver at least one of acquiring and generating a position signal indicative of a current vehicle location;
wherein the controller is communicatively coupled to the receiver and disables at least one of the camera and the storage device, in response to determining that the current vehicle location is a restricted location for video surveillance.

3. The on-vehicle video recording system of claim 2, wherein the storage device is at least one of a USB memory stick device, an SD memory card, a wireless mobile device, a server associated with a wireless network and an on-vehicle data storage device.

4. The on-vehicle video recording system of claim 2, further comprising a human machine interface that is communicatively coupled to the controller and integrated within at least one of an on-vehicle instrument panel cluster, an on-vehicle touch screen display, a mobile wireless device, a voice recognition controller interface and a mechanical switch interface.

5. The on-vehicle video recording system of claim 2, wherein the storage device stores a reference lookup table including the restricted location and an associated disable signal for terminating a transfer of video data from the RAM device to the storage device when the vehicle is located in the restricted location.

6. The on-vehicle video recording system of claim 5, further comprising a human machine interface that is communicatively coupled to the controller and communicates a message indicating a status of the recording system, in response to the controller transmitting a status signal to the human machine interface.

7. The on-vehicle video recording system of claim 5, wherein the controller is configured to delete video data from the RAM device without saving the video data to the storage device.

8. The on-vehicle video recording system of claim 2, wherein the at least one sensor is an airbag sensor that generates the save-event signal in response to detecting an airbag deployment.

9. The on-vehicle video recording system of claim 2, wherein the at least one sensor is an accelerometer that generates the save-event signal in response to detecting at least one of:
a vehicle lateral acceleration that is higher than a predetermined lateral acceleration threshold;
a vehicle longitudinal deceleration that is higher than a predetermined longitudinal deceleration threshold; and
a vehicle vertical acceleration that is higher than a predetermined vertical acceleration threshold.

10. The on-vehicle video recording system of claim 2, wherein the at least one sensor is a brake pressure sensor generating the save-event signal in response to detecting a current brake pressure higher than a predetermined brake pressure threshold.

11. The on-vehicle video recording system of claim 2, wherein the at least one sensor is the receiver generating the save-event signal indicative of at least one of a current vehicle location, a current vehicle compass heading, a current road condition, a current road type, an approaching road type, a predicted travel path, an expected travel path, a current traffic condition and an approaching traffic condition.

12. The on-vehicle video recording system of claim 2, wherein the controller stores a driver profile including at least one driver performance parameter, and the controller transfers video data from the RAM device to the storage device, in response to the at least one sensor generating the save-event signal indicating that a current vehicle condition deviates from the at least one driver performance parameter by more than a predetermined threshold.

13. The on-vehicle video recording system of claim 12, wherein the controller transfers the video data from the RAM device to the storage device in response to the at least one sensor generating the save-event signal indicating that a current vehicle speed at a current location is more than at least one of the predetermined threshold higher than a posted speed limit and the predetermined threshold higher than an archived vehicle speed for the driver profile at the current location.

14. The on-vehicle video recording system of claim 2, wherein the at least one sensor includes at least one of a wheel speed sensor, a wheel slip sensor, a tire pressure sensor, an accelerometer, a radar device, a lidar device, a brake pressure sensor, an anti-locking brake sensor, an airbag sensor, a steering angle sensor, a throttle position sensor, a torque sensor, an infrared camera, a dedicated short range communications receiver, a receiver and a collision avoidance sensor, for detecting one of a crash event or pre-crash event.

15. A method of capturing video from a vehicle, comprising:
generating a video signal on an on-vehicle camera;
generating a save-event signal in response to detecting a vehicle event;
storing sensor data generated by at least one sensor and video data based on the video signal in a RAM device, in response to a controller receiving the save-event signal;
and
transferring the sensor data and the video data from the RAM device to a storage device in response to a controller receiving the save-event signal from the at least one sensor.

16. The method of claim 15, further comprising:
generating a position signal indicative of a current vehicle location;
storing the video signal to a storage device; and
disabling at least one of the camera and the storage device, in response to determining that the current vehicle location is a restricted location for video surveillance.

17. The method of claim 15, further comprising accessing a reference lookup table stored on the storage device, the reference lookup table including the restricted location and a disable signal associated with the restricted location for terminating a transfer of video data from a RAM device to the storage device.

18. The method of claim 15, further comprising displaying a message indicating that the recording system is disabled, in response to a controller transmitting a disable signal to the human machine interface.

19. The method of claim 15, further comprising at least one of:
disabling the on-vehicle camera; and
deleting the data from the RAM device.

20. The method of claim 15, further comprising receiving the save-event signal from at least one sensor that is at least one of an airbag sensor, an accelerometer, a brake pressure sensor, a receiver, a wheel speed sensor, a wheel slip sensor, a tire pressure sensor, a radar device, a lidar device, an anti-locking brake sensor, a steering angle sensor, an infrared camera, a dedicated short range communications receiver and a collision avoidance sensor.
